(19) United States
(12) Patent Application Publication
(10) Pub. No.: US 2023/0391229 A1
(43) Pub. Date: Dec. 7, 2023

(54) Seat Arrangement in a Passenger Compartment of a Vehicle

(71) Applicant: Bayerische Motoren Werke Aktiengesellschaft, Muenchen (DE)

(72) Inventors: Wolfgang GRUENER, Eichenau (DE); Dieter STRASSER, Oberhausen (DE)

(21) Appl. No.: 18/022,016

(22) PCT Filed: Sep. 24, 2021
(86) PCT No.: PCT/EP2021/076312

§ 371 Date: Feb. 17, 2023

(30) Foreign Application Priority Data
Oct. 1, 2020 (DE) 10 2020 125 675.2

(51) Int. Cl. B60N 2/01; B60N 2/02; B60N 2/20; B60N 2/22

(52) U.S. Cl. CPC B60N 2/01; B60N 2/0292; B60N 2/20; B60N 2/22

(57) ABSTRACT

A seat arrangement in a passenger compartment of a vehicle, in which seat arrangement some of the seats are designed as a reclining seat which can be brought from an upright, seated position to a reclining or resting position in which the backrest is inclined far towards the rear, is characterized in that the seat arrangement has five seats, of which at least three seats are designed as reclining seats.

### BACKGROUND AND SUMMARY

The invention relates to a seat arrangement in a passenger compartment of a vehicle, in particular a motor vehicle. It furthermore relates to a vehicle, in particular a motor vehicle, with such a seat arrangement.

In future autonomous vehicles, it will be possible for the vehicle occupants to assume resting or relaxing phases for longer periods in which the vehicle is driven autonomously, for which they require resting or reclining seats. Resting or reclining seats are seats in which the backrest can be adjusted from a substantially upright backrest position (seating position) into a moderately rearwardly sloping resting position (relaxing position) and/or into a more greatly rearwardly sloping reclining position. In the resting or relaxing position, the slope angle of the backrest to the vertical, i.e. the rake, is greater than 45° and preferably lies in a range between 45° and 50° to the vertical. In the reclining position, the rake is greater than 50° and preferably lies in the range between 50° and 60° to the vertical. The “vertical” here means the vehicle vertical axis (Z axis).

Until now, it has been usual to arrange the seats of a front vehicle seat row as reclining seats. In business vehicles of the upper and luxury class, the seats of the rear seat row, configured as individual seats, also have backrests which can be tilted to a lesser extent but cannot assume a reclining seat position. However, no more than four seats are provided in these vehicles, which restricts their suitability for everyday use, for which a fifth seat is required.

DE 10 2013 000 632 A1 shows and describes a seat arrangement in a motor vehicle with two seat rows, the two front seats of which are configured as reclining seats. The two rear seats have a foldable backrest.

The object of the present invention is to provide a generic seat arrangement in a passenger compartment of a vehicle in which both the number of seats is higher than in the prior art, and in which more than only two seats usable as reclining seats are provided.

This object is achieved with the features of the independent claim.

A seat arrangement in a passenger compartment of a vehicle, wherein some of the seats are designed as reclining seats which can be brought from an upright seating position into a reclining or resting position in which the backrest slopes far towards the rear, is distinguished according to the invention in that the seat arrangement has five seats, of which at least three seats are designed as reclining seats.

The design of the seat arrangement according to the invention allows the provision of five seats in the vehicle, of which at least three seats are configured as reclining seats.

Further preferred and advantageous design features of the seat arrangement according to the invention are the subject of the dependent claims.

Preferably, the seat arrangement has three seat rows arranged one behind the other in the vehicle longitudinal direction.

It is particularly advantageous here if the seat arrangement has three seat lines arranged next to one another in the vehicle transverse direction, which determine at least one left outer seat position, at least one right outer seat position and/or at least one middle seat position.

It is furthermore advantageous if the first seat row has two front seats arranged next to and spaced apart from one another in the vehicle transverse direction, which are configured as reclining seats, wherein a first left front seat is positioned in the left seat line and a second right front seat is positioned in the right seat line, and wherein the lateral spacing of the backrests of the front seats in their reclining or resting position, in the vehicle transverse direction, is greater than the width of the middle seat; the second seat row has a centrally arranged middle seat which is positioned in the middle seat line; and the third seat row has two rear seats arranged next to and spaced apart from one another in the vehicle transverse direction, wherein a first left rear seat is positioned in the left seat line and a second right rear seat is positioned in the right seat line.

It is advantageous here if, in addition to the two seats of the first seat row, the middle seat in the second seat row is configured as a reclining seat.

Here, the rear seats in the third seat row are preferably configured as folding seats.

It is also advantageous if the rear seats in the third seat row can be unfolded from and folded back into a stowage position in a respective stowage compartment.

Alternatively, the two rear seats in the third seat row are configured as reclining seats.

Here, the middle seat in the second seat row is preferably configured as a folding seat.

It is particularly advantageous here if the middle seat in the second seat row can be unfolded from and folded back into a stowage position in a stowage compartment.

The present invention is also directed to a motor vehicle with a seat arrangement according to the invention.

Preferred exemplary embodiments of the invention with additional design details and further advantages are described in more detail and explained below with reference to the appended drawings.

### BRIEF DESCRIPTION OF THE DRAWINGS

FIG. 1 shows a first variant of a seat arrangement according to an embodiment of the invention; and

FIG. 2 shows a second alternative variant of a seat arrangement according to an embodiment of the invention.

### DETAILED DESCRIPTION OF THE DRAWINGS

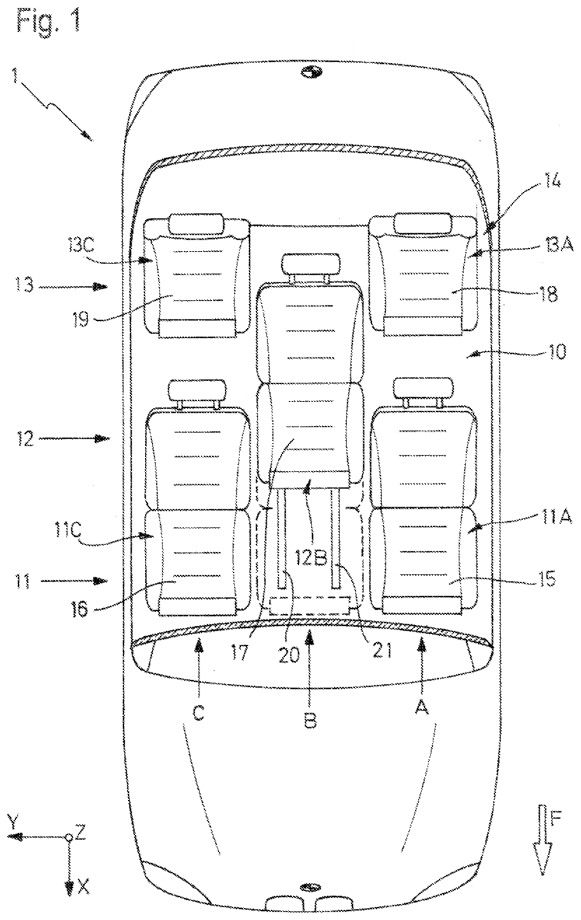

FIG. 1 shows a schematic top view of a first variant of a seat arrangement 14 in a passenger compartment 10 of a motor vehicle 1. This seat arrangement 14 has three seat rows arranged one behind the other in the vehicle longitudinal direction X, namely a first front seat row 11, a second middle seat row 12, and a third rear seat row 13.

Furthermore, the seat arrangement has three seat lines (columns) arranged next to one another in the vehicle transverse direction Y, namely a first left seat line A in the direction of travel F, a second middle seat line B and a third right seat line C. The left seat line A forms a left outer front seat position 11A in the first seat row 11, and a left outer rear seat position 13A in the third seat row 13. The right seat line C forms a right outer front seat position 11C in the first seat row 11 and a right outer rear seat position 13C in the third seat row 13. The middle seat line B forms a middle seat position 12B in the second seat row 12.

In the example of FIG. 1, the two front seat positions 11A and 11C and the middle seat position 12B are formed with reclining seats 15, 16, 17. The two rear seat positions 13A and 13C are formed with regular seats 18, 19 without a resting or reclining seat function, or with folding seats. In a short vehicle with restricted interior length (in the X direction), the rear seats 18, 19 in the third seat row 13 are configured as folding seats which can be lowered into the vehicle floor or a stowage compartment, or alternatively they are each equipped with a backrest which can be folded down forwards onto the seat base, in order to create space for the rearwardly sloping backrests of the front seats 15, 16 in their resting or reclining seat position.

The mutual lateral spacing of the backrests of the front seats 15, 16 in their reclining or resting position, in the vehicle transverse direction Y, is greater than the width of the middle seat 17, so that the backrests of the two front seats 15, 16 and the seat base of the middle seat 17, in the respective resting or reclining position, have space next to one another in the region of the second seat row 12.

In this way, the seat arrangement 14 of FIG. 1 comprises five usable seats, three seats of which have a reclining seat function.

In this embodiment of the invention, the reclining seats are situated on the left and right in the first seat row 11, and in the middle in the second seat row 12. No further seats are present in the second seat row 12. With this central arrangement of the seat 17 in the second seat row 12, both the two front reclining seats 15, 16 and also the middle reclining seat 17 of the second seat row 12 can be brought into a reclining position. This is because the middle reclining seat 17 of the second seat row 12 is positioned further towards the back than the seats 16 of the first seat row 11. The legs of a passenger lying on the middle seat 17, in its resting or reclining position, lie between the front reclining seats 15, 16 of the first seat row 11. The fourth and fifth seats 18, 19 may each be configured as folding seats. These two rear folding seats 18, 19 may still be used even when all reclining seats 15, 16, 17 are in use.

Preferably, the mutual lateral spacing between the front seats 15, 16 in their upright seating position is greater than the width of the middle seat 17. This allows the middle seat 17 to be arranged on corresponding rails 20, 21 in the vehicle 1 so as to slide in the vehicle longitudinal direction X, so that in a resting position, it can be positioned in the middle seat line B in the front seat row 11, i.e. between the two front seats 15, 16 (drawn in dotted lines in FIG. 1), and when the three seats 15, 16, 17 shown in FIG. 1 are used in their respective resting or reclining seat position, it can be moved rearwards into the middle seat row 12. Alternatively, the middle seat 17 may also be fixedly positioned in the middle seat position 12B.

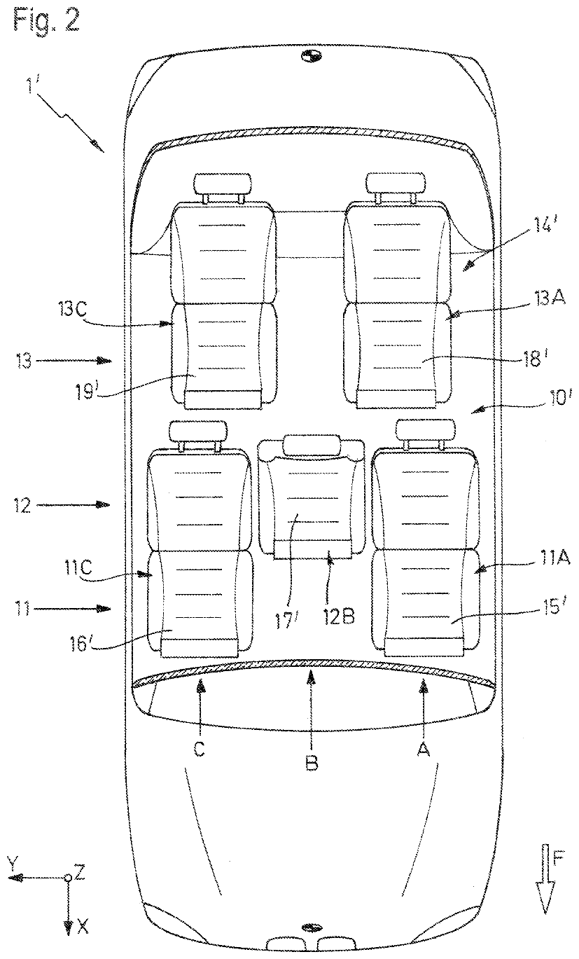

The example of FIG. 2 shows an alternative seat arrangement 14′ in a passenger compartment 10′ of a motor vehicle 1′, which has the same division of seat rows and seat lines as the seat arrangement 14 in the example of FIG. 1. In this example, the two front seat positions 11A and 11C are also formed with reclining seats 15′, 16′. The middle seat position 12B is here filled by a seat 17′ without a resting or reclining seat function, or by a folding seat. The two rear seat positions 13A and 13C are again formed with reclining seats 18′, 19′. In this way, the seat arrangement 14′ of FIG. 2 also comprises five usable seats, in which however four seats have a reclining seat function.

The reclining seats 15′, 16′, 18′, 19′ are situated on the left and right in the first seat row 11 and in the third seat row 13. In the middle of the second seat row 12 is the seat 17′, which is preferably configured as a folding seat with no resting or reclining seat function, and with integrated safety belt. No further seats are present in the second seat row.

To use all four reclining seats in a small vehicle with restricted vehicle width, in which the lateral spacing between the two front seats 15′ and 16′ is smaller than the width of the middle seat 17′, this seat 17′, which is configured as a folding seat of the second seat row, is lowered into the vehicle floor or into a stowage compartment. Thus it is possible to bring the seats of the first seat row 11 and third seat row 13 into the resting or reclining position. Also, all seats, including reclining seats, may be equipped with an integrated safety belt in both examples shown.

The invention is not restricted to the above exemplary embodiments which serve purely for general explanation of the core concept of the invention. Within the scope of protection, the device according to the invention may rather assume embodiments other than those described above. The device may here in particular have features which constitute a combination of the respective individual features of the claims.

Reference signs in the claims, description and drawings serve purely for better understanding of the invention and do not restrict the scope of protection.

1.-10. (canceled)

11. A seat arrangement in a passenger compartment of a vehicle, comprising:
five seats in the vehicle, wherein
at least three of the five seats are configured as reclining seats that are brought from an upright seating position into a reclining or resting position in which a backrest of the seat slopes far towards a rear of the vehicle.

12. The seat arrangement according to claim 11, wherein
the seat arrangement has a first, a second and a third seat row arranged one behind the other in a vehicle longitudinal direction.

13. The seat arrangement according to claim 12, wherein
the seat arrangement has three seat lines arranged next to one another in a vehicle transverse direction, which three seat lines determine at least one left outer seat position, at least one right outer seat position and/or at least one middle seat position.

14. The seat arrangement according to claim 13, wherein
the first seat row has two front seats arranged next to and spaced apart from one another in the vehicle transverse direction, which are configured as reclining seats,
a first left front seat of the first seat row is positioned in a left seat line and a second right front seat of the first seat row is positioned in a right seat line, and
lateral spacing of the backrests of the first and second front seats in a reclining or resting position, in the vehicle transverse direction, is greater than a width of a middle seat,
the second seat row has the middle seat centrally arranged and positioned in the middle seat line, and
the third seat row has two rear seats arranged next to and spaced apart from one another in the vehicle transverse direction, wherein a first left rear seat of the third seat row is positioned in the left seat line and a second right rear seat of the third seat row is positioned in the right seat line.

15. The seat arrangement according to claim 14, wherein
the middle seat in the second seat row is configured as a reclining seat.

16. The seat arrangement according to claim 15, wherein
the two rear seats in the third seat row are configured as folding seats.

17. The seat arrangement according to claim 16, wherein
the two rear seats in the third seat row are unfoldable from and foldable back into a stowage position in a respective stowage compartment of the vehicle.

18. The seat arrangement according to claim 14, wherein
the two rear seats in the third seat row are configured as reclining seats.

19. The seat arrangement according to claim 18, wherein
the middle seat in the second seat row is configured as a folding seat.

20. The seat arrangement according to claim 19, wherein
the middle seat in the second seat row is unfoldable from and foldable back into a stowage position in a stowage compartment of the vehicle.
